(19) United States
(12) Patent Application Publication
(10) Pub. No.: US 2025/0139749 A1
(43) Pub. Date: May 1, 2025

(54) RANGE ADAPTIVE DYNAMIC METADATA GENERATION FOR HIGH DYNAMIC RANGE IMAGES

(71) Applicant: SAMSUNG ELECTRONICS CO., LTD, Gyeonggi-Do (KR)

(72) Inventors: Chenguang Liu, Tustin, CA (US); Dung Trung Vo, Costa Mesa, CA (US); Aparajith Srinivasan, Irvine, CA (US); McClain Craig Nelson, Anaheim, CA (US)

(21) Appl. No.: 18/883,557

(22) Filed: Sep. 12, 2024

Related U.S. Application Data
(60) Provisional application No. 63/545,726, filed on Oct. 25, 2023.

(51) Int. Cl. G06T 5/92; G06T 5/40; G06V 10/60

(52) U.S. Cl. CPC G06T 5/92; G06T 5/40; G06V 10/60; G06T 2207/20208

(57) ABSTRACT

Range adaptive, dynamic metadata generation for high-dynamic images includes generating, using computer hardware, histogram-based data for video including one or more frames. The histogram-based data is generated for each of a plurality of dynamic ranges. For each dynamic range, a predetermined amount of dynamic metadata for the video is generated from the histogram-based data for the dynamic range. The video and the dynamic metadata is output.

### CROSS-REFERENCE TO RELATED APPLICATIONS

This application claims the benefit of U.S. Application No. 63/545,726 filed on Oct. 25, 2023, which is fully incorporated herein by reference.

### TECHNICAL FIELD

This disclosure relates to displaying high dynamic range (HDR) images and, more particularly, to generating range adaptive dynamic metadata tone mapping HDR images.

### BACKGROUND

High Dynamic Range (HDR) images are images that capture a dynamic range that is greater than the dynamic range that may be captured in an image generated by a standard dynamic range camera sensor. The term “dynamic range” refers to the difference between the lightest light and the darkest dark of an image. HDR tone mapping is a technology used to display HDR images on display devices that have a limited dynamic range. That is, HDR tone mapping technology is used to display images, e.g., HDR images, that have a higher dynamic range than the display device used to display the images.

As an example, many HDR images have a dynamic range of several thousand NITS, while many display devices have smaller dynamic ranges of several hundred NITS or in some cases up to approximately 1000 NITS. Television screens, computer monitors, and mobile device displays are a few examples of different types of display devices with limited dynamic range. Appreciably, the peak luminance of a tone-mapped image as displayed cannot exceed the peak luminance of the display device. HDR tone mapping technology reduces the dynamic range of an HDR image to match the dynamic range of the display device upon which the HDR image is displayed while seeking to preserve as much detail and contrast as possible.

In many cases, tone-mapped images as displayed appear darker than the HDR images pre-tone mapping. A tone-mapped image often lacks detail in one or more regions of the image as displayed thereby appearing to viewers to be a significant deviation from the HDR image pre-tone mapping. The deviation may be significant enough that the original creative intent behind the pre-tone-mapped images is lost in the tone-mapped images.

### SUMMARY

In one or more embodiments, a method includes generating, using computer hardware, histogram-based data for video including one or more frames. The histogram-based data is generated for each of a plurality of dynamic ranges. The method includes, for each dynamic range, generating, using the computer hardware, a predetermined amount of dynamic metadata for the video from the histogram-based data for the dynamic range. The method includes outputting the video and the dynamic metadata for the plurality of dynamic ranges.

In one or more embodiments a system includes a memory capable of storing program instructions and a processor coupled to the memory. The processor is capable of executing the program instructions to perform operations. The operations include generating histogram-based data for video including one or more frames. The histogram-based data is generated for each of a plurality of dynamic ranges. The operations include, for each dynamic range, generating a predetermined amount of dynamic metadata for the video from the histogram-based data for the dynamic range. The operations include outputting the video and the dynamic metadata for the plurality of dynamic ranges.

In one or more embodiments, a computer program product includes a computer readable storage medium having program instructions embodied therewith. The program instructions are executable by computer hardware, e.g., a processor, to cause the computer hardware to perform operations. The operations include generating histogram-based data for video including one or more frames. The histogram-based data is generated for each of a plurality of dynamic ranges. The operations include, for each dynamic range, generating a predetermined amount of dynamic metadata for the video from the histogram-based data for the dynamic range. The operations include outputting the video and the dynamic metadata for the plurality of dynamic ranges.

This Summary section is provided merely to introduce certain concepts and not to identify any key or essential features of the claimed subject matter. Many other features and embodiments of the disclosed technology will be apparent from the accompanying drawings and from the following detailed description.

### BRIEF DESCRIPTION OF THE DRAWINGS

The accompanying drawings show one or more embodiments of the disclosed technology; however, the accompanying drawings should not be taken to limit the disclosed technology to only the embodiments shown. Various aspects and advantages will become apparent upon review of the following detailed description and upon reference to the drawings.

FIG. 1 illustrates a computing environment in accordance with one or more embodiments of the disclosed technology.

FIG. 2 illustrates an example of a cumulated distribution function (CDF) curve for a High Dynamic Range (HDR) frame/scene.

FIG. 3 illustrates the CDF curve of FIG. 2 with different dynamic ranges in accordance with one or more embodiments of the disclosed technology.

FIG. 4 illustrates an implementation of range-adaptive dynamic (RAD) metadata generator in accordance with one or more embodiments of the disclosed technology.

FIG. 5 illustrates a method illustrating certain operative features of the RAD metadata generator of FIG. 4 in accordance with one or more embodiments of the disclosed technology.

FIG. 6 illustrates an example of a dark CDF in greater detail.

FIG. 7 illustrates an example of dynamic metadata generated by the RAD metadata generator.

FIG. 8 illustrates an example implementation of a data processing system for use with the inventive arrangements.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to displaying high dynamic range (HDR) images and, more particularly, to generating dynamic metadata for displaying HDR images. Conventional techniques used to generate metadata for use in HDR tone mapping embrace a global perspective in representing a tonality for video. Conventional metadata describes the entire dynamic range of a frame or scene as a single, continuous dynamic range referred to herein as a “global dynamic range.” The items of metadata that are generated are apportioned or spaced throughout this global dynamic range. This approach often results in a lack of sufficiently detailed information for particular regions of the global dynamic range of the frame or scene. When performing HDR tone mapping on these regions of the frame or scene, use of this sparse metadata for HDR tone mapping results in a loss of detail and contrast in the regions of the frame or scene as displayed by a display device.

As an illustrative example, conventional metadata used for HDR tone mapping samples the global dynamic range at increments of 10%. This approach, however, is inadequate to capture certain regions of the tone mapping curve that correspond to dark and/or bright regions of the frame or scene. In consequence, the tone-mapped frame or scene as displayed, even with the availability of the metadata, often appears dark and lacking in detail. The change in the frame or scene as displayed compared to the frame or scene pre-tone-mapping often deviates to such a degree that the original intent of the video creator(s) is lost.

In accordance with the inventive arrangements described within this disclosure, methods, systems, and computer program products are provided that are capable of generating dynamic metadata for frames or scenes of video. The dynamic metadata is generated for each of a plurality of different dynamic ranges. The dynamic metadata generated for a given frame or scene specifies a tonality representation of the video that may be used for HDR tone mapping of the frame or scene as displayed by a display device.

Unlike conventional metadata often used in HDR tone mapping, the dynamic metadata is generated for each of a plurality of different dynamic ranges. Each dynamic range is a portion or region of the global dynamic range of the video. The embodiments provide a more accurate tonality representation for HDR tone mapping that preserves the creative intention in frames and/or scenes that results in tone-mapped frames and/or scenes, as displayed, that more closely match the original creative intention of the video creator(s). The inventive arrangements are capable of generating the dynamic metadata as range adaptive statistics information that may be used by HDR content creators.

In one or more embodiments, histogram-based data for video including one or more frames is generated. The histogram-based data is generated for each of a plurality of dynamic ranges. For each dynamic range, a predetermined amount of dynamic metadata is generated from the histogram-based data for the dynamic range. The video and the dynamic metadata for the plurality of dynamic ranges are output. By generating and providing a predetermined amount of dynamic metadata for each dynamic range, the embodiments ensure that at least a minimum amount of dynamic metadata is provided for each of the different dynamic ranges. Thus, a sufficient or increased amount of metadata is generated for one or more of the dynamic ranges. The amount of metadata provided in such dynamic ranges exceeds the amount of metadata provided for the same regions of frames and/or scenes using the global dynamic range approach.

In another aspect, the dynamic metadata for the plurality of dynamic ranges specifies a tonality representation of the video for HDR tone mapping. That is, the dynamic ranges, taken collectively, specify a tonality representation in the form of a tone mapping curve that, in effect, specifies a more detailed version of the global dynamic range. As noted, the effect of using multiple dynamic ranges as opposed to one global dynamic range is obtaining a larger quantity of dynamic metadata for one or more of the dynamic ranges that specifies the certain regions of the global dynamic range in greater detail.

In another aspect, the plurality of dynamic ranges includes at least one of a dark dynamic range or a bright dynamic range. For example, the plurality of dynamic ranges may include a dark dynamic range, a mid-tone dynamic range, and a bright dynamic range. The defining and inclusion of particular dynamic ranges such as the dark and/or bright dynamic ranges leads to the generation of at least minimum amounts of dynamic metadata for specifically targeted dynamic regions than would otherwise have sparse metadata. This allows the video to be HDR tone-mapped, using the dynamic metadata for the different dynamic ranges, and displayed with greater accuracy, improved contrast, and/or improved detail.

In another aspect, the dynamic metadata for each dynamic range specifies percentile information and luminance information. For example, the dynamic metadata for each dynamic range specifies a predetermined number of percentile-luminance pairs. The predetermined number of percentile-luminance pairs for each dynamic range of the plurality of dynamic ranges is independently specified. The embodiments allow the particular number of data items to be specified on a per dynamic region basis. This allows each dynamic region to have a number of data items in the dynamic metadata deemed sufficient to represent contrast and detail in that particular region of the video. Otherwise, when metadata is specified for the global dynamic range without the enumeration of different dynamic regions therein, such dynamic regions may have too little metadata to adequately describe the HDR tone mapping curve.

In another aspect, the plurality of dynamic ranges is defined by one or more luminance thresholds. Each luminance threshold defines a boundary separating adjacent dynamic ranges of the plurality of dynamic ranges. The number of luminance threshold(s) and the location of the luminance threshold(s) may be predetermined. The luminance thresholds may be specified, however, and as such changed, from one video, frame, and/or scene to another depending on need given the attributes of the video itself. This allows the definition of a particular dynamic range, e.g., dark and/or bright, to be adjusted in an adaptive manner for a given video, for different videos, and/or for different portions or segments of a video. In some aspects, luminance thresholds, whether location or number, may be adjusted on a per frame, per scene, and/or per video basis.

In another aspect, generating the histogram-based data includes generating a maximum red-green-blue (RGB) frame for a selected frame of the video, generating a range-specific maximum RGB frame for each dynamic range of the plurality of dynamic ranges, generating a range-specific histogram for each range-specific maximum RGB frame, and generating a range-specific cumulated distribution function (CDF) for each range-specific histogram. Generating the predetermined amount of dynamic metadata may include generating one or more percentile-luminance pairs from each range-specific CDR.

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

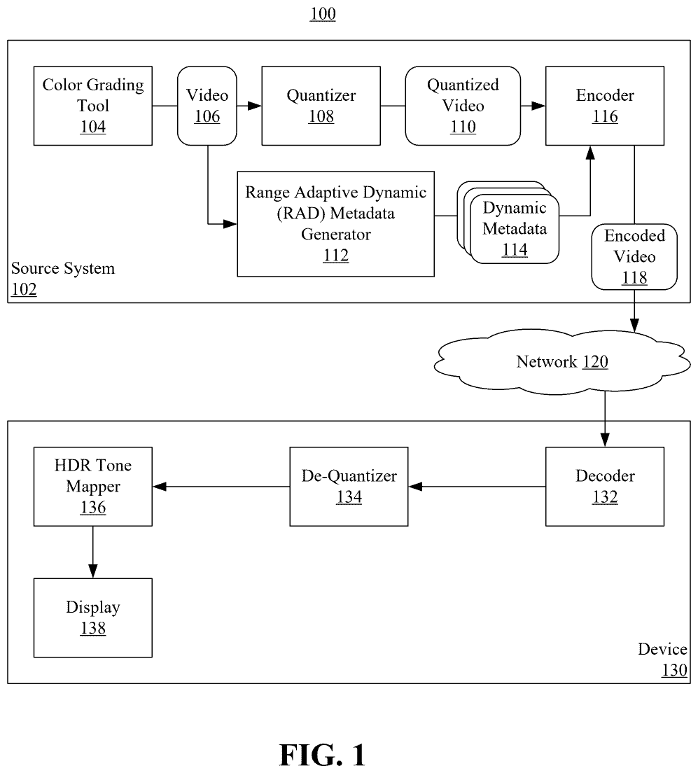

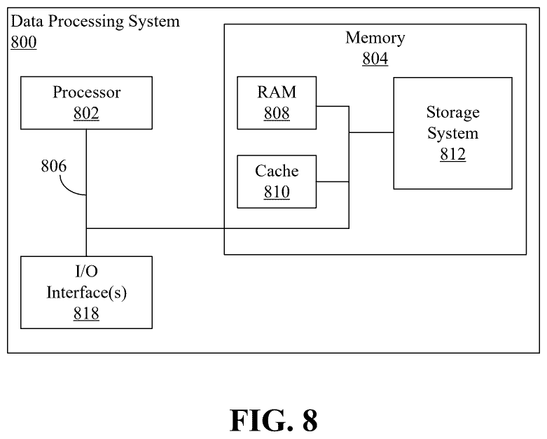

FIG. 1 illustrates a computing environment 100 in accordance with one or more embodiments of the disclosed technology. Computing environment 100 includes a source system 102 and a device 130. In general, source system 102 may be implemented as a data processing system. For example, source system 102 may be implemented as a computer-based video editing system (e.g., a dedicated video editing system or a computer executing suitable video editing program instructions or software). An example of a data processing system that may be used to implement source system 102 is described in connection with FIG. 8.

In general, source system 102 is capable of generating and/or outputting video formed of one or more frames. The frames may be organized into one or more scenes. As generally understood, a “frame” refers to a single image, e.g., a single still image. In the context of video, a frame is an image that is played in sequence with one or more other frames to create motion on a playback surface for the frames. A “scene” refers to two or more, e.g., a plurality, of sequential frames of video. Throughout this disclosure, the expression “frame/scene” is used to mean “frame and/or scene.” Further, the term “frame” is used synonymously with the term image.

In the example of FIG. 1, source system 102 includes a color grading tool 104, a quantizer 108, a Range-Adaptive Dynamic (RAD) metadata generator 112, and an encoder 116. The various blocks illustrated in source system 102 (e.g., color grading tool 104, quantizer 108, RAD metadata generator 112, and/or encoder 116) may be implemented as hardware or as a combination of hardware and software (e.g., a hardware processor executing program instructions). For purposes of illustration, color grading tool 104 is capable of operating on a video, e.g., a source video not shown, to perform color correction operations on the source video. The processed video may be output from color grading tool 104 as video 106 and provided to quantizer 108 and to RAD metadata generator 112. Video 106 is formed of one or more HDR frames. The HDR frames may be organized into one or more scenes.

Quantizer 108 is capable of quantizing video 106 and outputting quantized video 110 to encoder 116. In one or more embodiments, quantizer 108 is capable of applying an Electro-Optical Transfer Function (EOTF) to video 106. The EOTF, for example, converts video 106 into linear light output for a display device. Examples of EOTFs that may be applied to video 106 include, but are not limited to, any of the available Gamma, Logarithmic, and/or HDR transfer functions. It should be appreciated that the particular examples of EOTFs referenced within this disclosure are provided for purposes of illustration and not limitation. The embodiments described within this disclosure may be used with any of a variety of available and/or to be developed EOTFs.

RAD metadata generator 112 is capable of generating dynamic metadata 114 for each of a plurality of different ranges of the global dynamic range of video 106. In the example, RAD metadata generator 112 outputs dynamic metadata 114 to encoder 116. A set of dynamic metadata 114 is provided for each of the different dynamic ranges. Encoder 116 is capable of encoding quantized video 110 and dynamic metadata 114 using any of a variety of different video encoding techniques and outputting encoded video 118. Encoded video 118 specifies one or more HDR frames/scenes and the corresponding dynamic metadata 114.

For purposes of illustration, encoded video 118 may be output or provided to another device and/or system. For purposes of illustration, encoded video 118 may be conveyed over a network 120 as shown to device 130. In other embodiments, encoded video 118 may be conveyed to another device such as device 130 via a data storage medium (e.g., a data storage device) or other communication link. Device 130 may represent any of a variety of different types of devices such as another data processing system or a display device. For example, device 130 may represent a mobile device, a television, a computer monitor, wearable computing devices with a display such as a smartwatch, virtual reality glasses, augmented reality glasses, mixed-reality glasses, or the like. Device 130 may be implemented using the example data processing system architecture of FIG. 8 or another similar thereto. Device 130 will include a display, screen, or other surface on which HDR frame/scenes may be rendered, displayed, or projected.

In the example of FIG. 1, device 130 includes a decoder 132, a de-quantizer 134, an HDR tone mapper 136, and a display 138. The various blocks illustrated in device 130 (e.g., decoder 132, de-quantizer 134, HDR tone mapper 136, and display 138) may be implemented as hardware or as a combination of hardware and software. Decoder 132 decodes encoded video 118 and provides the video and dynamic metadata 114 as decoded to de-quantizer 134. De-quantizer 134 provides the de-quantized video and dynamic metadata 114 to HDR tone mapper 136. HDR tone mapper 136 is capable of performing tone mapping on the de-quantized video (e.g., the HDR frames/scenes) based on dynamic metadata 114 and rendering or displaying the HDR tone-mapped frames/scenes to display 138.

It should be appreciated that the particular technique and/or algorithm used to perform HDR tone mapping may be specific to device 130. Each different display device provider, for example, is capable of interpreting dynamic metadata 114 and adjusting features of the HDR frames/scenes such as luminance to achieve a desired quality of video playback. In this regard, while various embodiments the disclosed technology provide dynamic metadata 114 across a plurality of different ranges, the interpretation of that dynamic metadata 114 for purposes of performing HDR tone mapping and/or the display of HDR images/scenes may vary. That is, the generation and/or existence of dynamic metadata 114 included with video (e.g., as in encoded video 118) is not intended as a limitation with respect to the particular manner or technique used to perform HDR tone mapping.

FIG. 1 is provided to illustrate an example use case for the embodiments described within this disclosure. Computing environment 100 is not intended as a limitation of the use of dynamic metadata 114 and/or the context in which dynamic metadata 114 may be used. Further, computing environment 100 is not intended as a limitation of the use of, and/or context in which, RAD metadata generator 112 may be used.

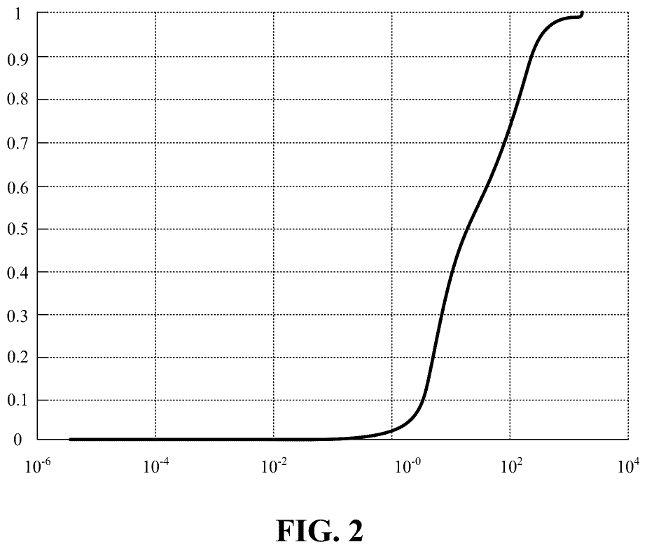

FIG. 2 illustrates an example of a CDF curve for an HDR frame/scene. In the example of FIG. 2, the dynamic range is illustrated globally (e.g., without using separate dynamic ranges). In the example, the CDF, denoted as D(k) for (k=0, . . . , 1023) as generated from a histogram h(k) for (k=0, . . . , 1023) is shown for an HDR frame. As generally understood, h(k) specifics the number of pixels of the HDR frame at each gray level k. In the example of FIG. 2, for the CDF D(k) illustrated, the Y-axis of the curve represents the cumulative probability, or percentile, of the distribution. The X-axis represents the values of the distribution corresponding to luminance. In conventional HDR tone mapping, the entire CDF curve is treated from a global perspective as a single dynamic range. In conventional systems, metadata specifying the CDF curve for HDR tone mapping is generated by sampling the CDF curve at regular increments such as 10% across the entire dynamic range. This generates samples at 10%, 20%, 30%, etc., on to 100%, for example.

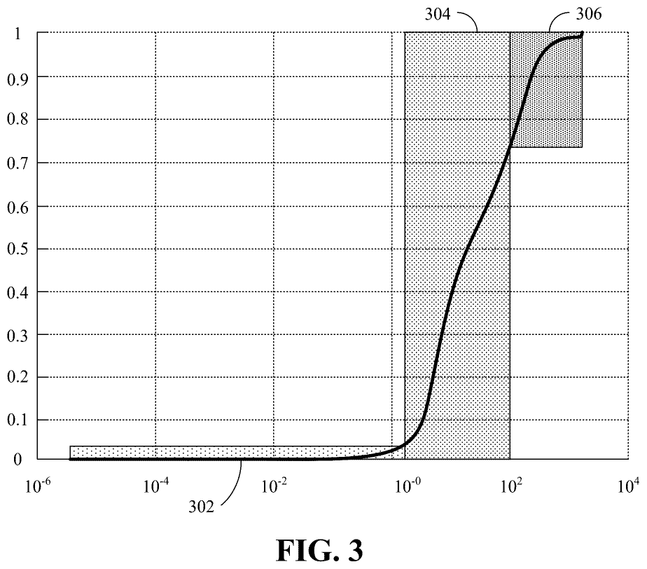

FIG. 3 illustrates the CDF curve of FIG. 2 with different dynamic ranges in accordance with one or more embodiments of the disclosed technology. As illustrated, the CDF curve from FIG. 2 is subdivided into several different dynamic ranges. In FIG. 3, different portions or regions of the CDF curve have been identified or defined as a dark dynamic range 302, a mid-tone dynamic range 304, and bright dynamic range 306. Each of dark dynamic range 302, mid-tone dynamic range 304, and bright dynamic range 306 is actually a sub-range or portion of the larger, global dynamic range. Taken collectively, dark dynamic range 302, mid-tone dynamic range 304, and bright dynamic range 306 represent the entire global CDF curve of the HDR frame/scene.

The example of FIG. 3 illustrates that the global CDF curve has narrow ranges for the dark dynamic range 302 and for the bright dynamic range 306. By creating a plurality of different dynamic ranges from the global dynamic range and setting a predetermined number of sample points for each such dynamic range, additional metadata may be generated that may be used to represent a greater amount of tonality information for purposes of HDR tone mapping. This availability of a larger amount of tonality information for regions of the CDF curve that were previously sparsely represented allows the HDR tone mapping process to preserver greater detail in the sparse regions of an HDR frame/scene as represented by the dark dynamic range and/or the bright dynamic range.

As an illustrative example, sampling the global CDF curve at increments of 10% captures little information for the dark dynamic range 302 and/or for the bright dynamic range 306. For example, for dark dynamic range 302 and for bright dynamic range 306, few sample points would be obtained compared to mid-tone dynamic range 304. A sample taken at y=0.1, for example, may be the only data point for the dark dynamic range 302 and conveys very little information as to the shape of the CDF curve within dark dynamic range 302. Similarly, the bright dynamic range 306, for example, may include only sample points at y=0.8 and y=0.9, which convey little information as to the shape of the CDF curve in bright dynamic range 306.

By subdividing the global dynamic range of an HDR image into a plurality of different dynamic ranges, each portion of the CDF curve may be specified or represented with a level of detail, e.g., an increased level of detail, compared to the conventional technique of using fixed sampling points across the global dynamic range or global CDF curve as the case may be.

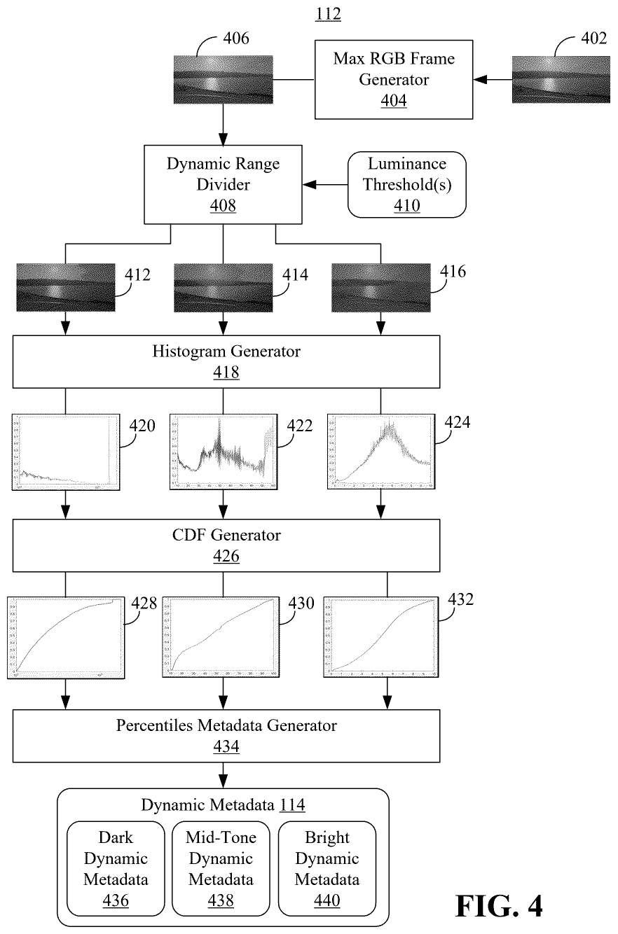

FIG. 4 illustrates an implementation of RAD metadata generator 112 in accordance with one or more embodiments of the disclosed technology. In the example of FIG. 4, RAD metadata generator 112 includes a maximum (max) RGB frame generator 404, a dynamic range divider 408, a histogram generator 418, a CDF generator 426, and a percentiles metadata generator 434.

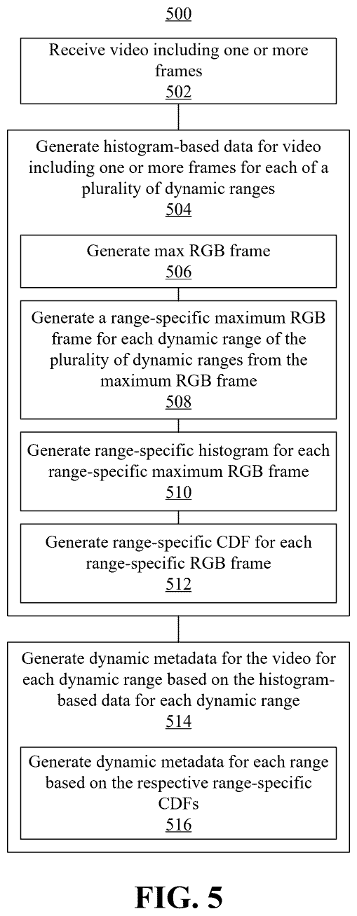

FIG. 5 illustrates a method 500 illustrating certain operative features of RAD metadata generator 112 in accordance with one or more embodiments of the disclosed technology. Referring to FIGS. 4 and 5 in combination, in block 502, max RGB frame generator 404 receives a video. The vide may include one or more frames/scenes. The frame(s) may be HDR frames. For example, max RGB frame generator 404 is capable of receiving one or more HDR frames 402 of video. As noted, an example of an HDR frame is an HDR image.

In the example of FIGS. 4 and 5, for case of illustration and discussion, the embodiments are described with reference to processing a single HDR frame. In other embodiments, RAD metadata generator 112 may be adapted to operate on a plurality of frames concurrently, e.g., a scene or an entire video. Further, the dynamic metadata that is generated, as described herein, may be generated and specified (e.g., encoded) on a per frame basis or on a per scene basis. That is, each HDR frame/scene may be encoded with its own corresponding dynamic metadata. In other cases, the dynamic metadata may be applied, or correspond to, an entire video.

In block 504, RAD metadata generator 112 is capable of generating histogram-based data for the video for each of a plurality of dynamic ranges. In the example of FIG. 5, block 504 includes a plurality of other operations corresponding to blocks 506, 508, and 510. In block 506, max RGB frame generator 404 is capable of generating a maximum RGB frame 406 from HDR frame 402. For example, for each HDR frame 402 received, max RGB frame generator 404 is capable of generating a corresponding maximum RGB frame 406.

As generally understood, to generate a maximum RGB frame, max RGB frame generator 404 is capable of analyzing HDR frame 402 and, for each pixel of HDR frame 402, selecting a maximum value from among the red, green, and blue pixel intensities. This operation may be denoted as Max(R, G, B). For each pixel, max RGB frame generator 404 keeps or maintains the value of the pixel intensity for the particular color of the pixel having the largest value and sets the value of the pixel intensity of each other color of the pixel (e.g., those less than the maximum) to zero. This generates maximum RGB frame 406 which only has three colors (e.g., red, green, and blue). In some cases, maximum RGB frame 406 includes pure gray, e.g., a single channel.

In block 508, dynamic range divider 408 is capable of generating a range-specific maximum RGB frame for each dynamic range of the plurality of dynamic ranges from the maximum RGB frame 406. Referring to FIG. 4, dynamic range divider 408 receives one or more luminance thresholds 410. Each luminance threshold 410 defines a boundary separating two adjacent dynamic ranges of the plurality of dynamic ranges. In the example of FIG. 4, three different dynamic ranges are used. These dynamic ranges include a dark range, a mid-tone range, and a bright range. The dynamic ranges correspond to the regions illustrated in FIG. 3 as dark dynamic range 302, mid-tone dynamic range 304, and bright dynamic range 306. In embodiments that use N different dynamic ranges, where N is an integer value of 2 or more, the number of luminance thresholds 410 required will be N-1. In this example, two thresholds are needed to support three dynamic ranges. One luminance threshold 410 specifies the boundary between dark dynamic range 302 and mid-tone dynamic range 304. The other luminance threshold 410 specifies the boundary between mid-tone dynamic range 304 and bright dynamic range 306.

While three different dynamic ranges are used in the examples of FIGS. 3, 4, and 5, it should be appreciated that the number of dynamic range may be 2, 3, or more than 3. In one or more embodiments, the dynamic ranges may include the following combinations: a dark dynamic range and a remaining portion of the global dynamic range; a bright dynamic range and a remaining portion of the global dynamic range; a dark dynamic range, a mid-tone dynamic range, and a bright dynamic range; or four or more dynamic ranges. In the example, having at least one dynamic range dedicated to a portion of the CDF curve that is typically is flatter or conveys less information is often preferred. For example, including one or both of the dark dynamic range and the bright dynamic range within the plurality of dynamic ranges will provide increased dynamic metadata for purposes of HDR tone mapping thereby leading to a tone-mapped HDR frame as displayed on a display device with higher quality and greater detail.

In the example of FIG. 4, dynamic range divider 408 generates the following range-specific maximum RGB frames from maximum RGB frame 406: a dark maximum RGB frame 412, a mid-tone maximum RGB frame 414, and a bright maximum RGB frame 416. For example, dynamic range divider 408 is capable of generating dark maximum RGB frame 412 as those pixels of maximum RGB frame 406 having a luminance less than or equal to the first luminance threshold T_{d} specifying a boundary between dark dynamic range 302 and mid-tone dynamic range 304. Dynamic range divider 408 is capable of generating mid-tone maximum RGB frame 414 as those pixels of maximum RGB frame 406 having a luminance greater than the first luminance threshold T_{d} and less than or equal to a second luminance threshold T_{b}, where the second luminance threshold T_{b} defines a boundary between mid-tone dynamic range 304 and bright dynamic range 306. Dynamic range divider 408 is capable of generating a bright maximum RGB frame 414 as those pixels of maximum RGB frame 406 having a luminance greater than the second luminance threshold T_{b}.

In one or more embodiments, the particular luminance thresholds used to define the different ranges may be predetermined. Such thresholds may be set so as to obtain improved results and/or provide more information in those portions of the dynamic range where data would otherwise be sparse. The predetermined luminance thresholds may be used to process one or more frames/scenes and/or an entire video. In one or more other embodiments, a first set of one or more predetermined luminance thresholds depending on the number of dynamic ranges used may be specified for a first frame/scene. Subsequently, a second and different set of one or more predetermined luminance thresholds may be used for a second frame/scene. The number of dynamic ranges and the particular thresholds to be used may be preprogrammed into RAD metadata generator 112.

In block 510, histogram generator 418 is capable of generating a histogram h for each range-specific maximum RGB frame. For example, histogram generator 418 is capable of generating a dark histogram 420, also referred to as h_{d}(L_{d}), for dark maximum RGB frame 412; a mid-tone histogram 422, also referred to as hₘ(Lₘ), for mid-tone maximum RGB frame 414; and a bright histogram 424, also referred to as h_{b}(L_{b}), for bright maximum RGB frame 416.

In block 512, CDF generator 426 is capable of generating a range-specific CDF D for each range-specific RGB frame. For example, CDF generator 426 is capable of generating a dark CDF 428 denoted as D_{d} from dark histogram 420 according to the expression D_{d}(k_{d})=Σ_{L}_{_{d}}>_{T}_{_{d}}h_{d}(L_{d}); a mid-tone CDF 430 denoted as Dₘ from mid-tone histogram 422 according to the expression Dₘ(kₘ)=Σ_{T}_{_{d}}≤_{L}_{ₘ}≤T_{b}hₘ(Lₘ); and a bright CDF 432 denoted as D_{b} from histogram 424 according to the expression D_{b}(k_{b})=Σ_{L}_{_{b}}>_{T}_{_{b}}h_{b}(L_{b}).

In block 514, RAD metadata generator 112 is capable of generating dynamic metadata for the video for each dynamic range based on the histogram-based data for each dynamic range. In the example of FIG. 5, block 514 includes one or more other operations corresponding to block 516. In block 516, percentiles metadata generator 434 is capable of generating dynamic metadata 114 for each dynamic range based on the respective range-specific CDFs. For example, percentiles metadata generator 434 is capable of generating dark dynamic metadata 436 from dark CDF 428, mid-tone dynamic metadata 438 from mid-tone CDF 430, and bright dynamic metadata 440 from bright CDF 432.

In one or more embodiments, the dynamic metadata for each dynamic range may be specified as percentile information and luminance information. Each data item of metadata, for example, may be specified to include percentile information and luminance information. As an illustrative and non-limiting example, a data item of dynamic metadata for a given dynamic range may specify the percentile information and the luminance information as a percentile-luminance pair. The number of percentile-luminance pairs, or data items, may be a predetermined number for each dynamic range. In one or more embodiments, the number of such percentile-luminance pairs in each dynamic range may be independently specified. In this regard, the particular number of data items of dynamic metadata for each dynamic range may be predetermined and may be the same or different.

In one or more embodiments, the number of data items of dynamic metadata in each dynamic range also may change over time for a given portion of video. That is, a particular number of percentile-luminance pairs for each dynamic range (where the particular number for each dynamic range may be independently specified) may be used for one or more first frames/scenes, while a different number of percentile-luminance pairs for each dynamic range (where the particular number for each dynamic range may be independently specified) may be used for one or more second frames/scenes.

In one or more embodiments, the format of a data item of dynamic metadata may be specified as (G_{dynamic_range}ⁱ, L_{dynamic_range}ⁱ). In this example, the dynamic range may be specified as “d” for dark, “m” for mid-tone, and “b” for bright. The index “i” indicates the percentile, e.g., the “ith percentile” for the specified dynamic range. Each dynamic range may therefore include a predetermined number of data items ranging from percentile 1 to 100. For example, each dynamic range may include a maximum of 100 different data items of dynamic metadata as opposed to some subset of 100 percentiles from the global dynamic range using conventional HDR metadata generation techniques.

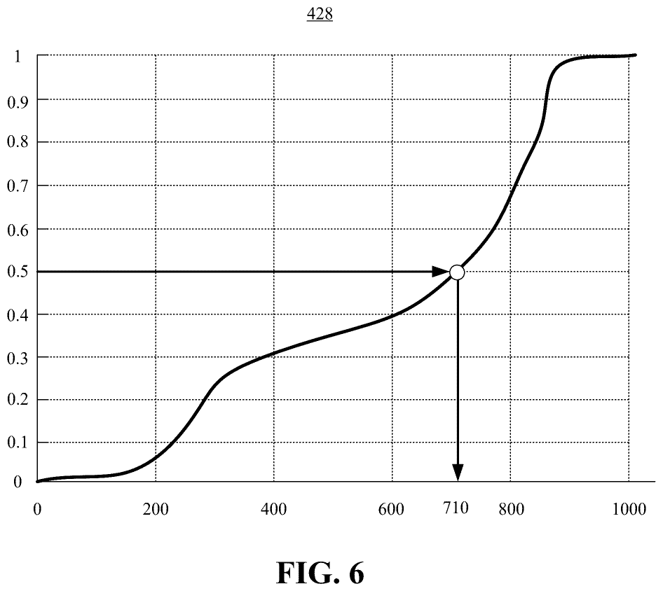

Accordingly, for the dark dynamic range (which corresponds to dark dynamic range 302, dark maximum RGB frame 412, dark, histogram 420, and dark CDF 428), the data items of dynamic metadata may be specified as (G_{d}ⁱ, L_{d}ⁱ), where i=1, . . . , n_{d}, where n_{d} is the number of percentiles that are included in the dynamic metadata for the dark dynamic range, G_{d}ⁱ is the ith percentile, and L_{d}ⁱ is the luminance of the percentile G_{d}ⁱ. In this example, n_{d} may be a predetermined number. For purposes of illustration, consider the percentile-luminance pair for the 50^{th} percentile (e.g., G_{d}⁵⁰). FIG. 6 illustrates dark CDF 428 in greater detail. Referring to FIG. 6, the luminance value for the 50^{th} percentile is 710. In the example of FIG. 6, the X-axis has a maximum value of 1023. The luminance value 710 from dark CDF 428 as illustrated in FIG. 6 may be converted into a normalized sampling code value C_{d}ⁱ by dividing the luminance value 710by 1023 such that C_{d}⁵⁰=710/1023. The luminance used for the percentile-luminance pair may be specified as L_{d}ⁱ=EOTC(C_{d}ⁱ), where the EOTC is the EOTC used in quantizer 108.

For the mid-tone dynamic range (which corresponds to mid-tone dynamic range 304, mid-tone maximum RGB frame 414, mid-tone histogram 422, and mid-tone CDF 430), the data items of dynamic metadata may be specified as (Gₘⁱ, Lₘⁱ), where i=1, . . . , nₘ, where nₘ is the number of percentiles that are included in the dynamic metadata for the mid-tone dynamic range, Gₘⁱ is the ith percentile, and Lₘⁱ is the luminance of the percentile Gₘⁱ, where Lₘⁱ is specified as Lₘⁱ=EOTC(Cₘⁱ). In this example, nₘ may be a predetermined number. The same procedure described in connection with the dark dynamic range in connection with FIG. 6 may be performed albeit using mid-tone CDF 430 for purposes of generating the percentile-luminance pairs for the mid-tone dynamic range.

For the bright dynamic range (which corresponds to bright dynamic range 306, bright maximum RGB frame 416, bright histogram 424, and bright CDF 432), the data items of dynamic metadata may be specified as (G_{b}ⁱ, L_{b}ⁱ), where i=1, . . . , n_{b}, where ng is the number of percentiles that are included in the dynamic metadata for the bright dynamic range, G_{b}ⁱ is the ith percentile, and L_{b}ⁱ is the luminance of the percentile G_{b}ⁱ, where L_{b}ⁱ is specified as L_{b}ⁱ=EOTC(C_{b}ⁱ). In this example, n_{b} may be a predetermined number. The same procedure described in connection with the dark dynamic range in connection with FIG. 6 may be performed albeit using bright CDF 432 for purposes of generating the percentile-luminance pairs for the bright dynamic range.

For each of the dynamic ranges used, the percentiles may be specified as linear luminance values that are sampled from the particular CDF for the dynamic range, e.g., the range-specific CDF. The data items in each dynamic range may be predefined, or predetermined, percentiles used for sampling purposes.

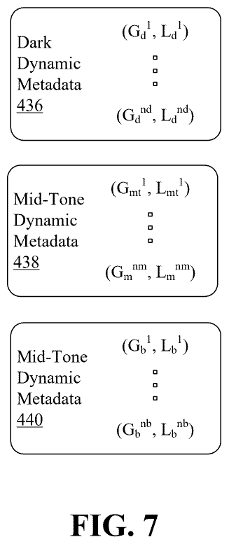

FIG. 7 illustrates an example of dynamic metadata 114. FIG. 7 illustrates example dynamic metadata 114 including dark dynamic metadata 436, mid-tone dynamic metadata 438, and bright dynamic metadata 440 each having one or more percentile-luminance pairs. As may be appreciated from the foregoing discussion, the particular dynamic metadata provided is adaptive to each respective dynamic range, e.g., is range adaptive.

FIG. 8 illustrates an example implementation of a data processing system 800. As defined herein, the term “data processing system” means one or more hardware systems configured to process data. Each hardware system includes at least one processor and memory, wherein the processor is programmed with computer-readable program instructions that, upon execution, initiate operations. Data processing system 800 can include a processor 802, a memory 804, and a bus 806 that couples various system components including memory 804 to processor 802.

Processor 802 may be implemented as one or more processors. In an example, processor 802 is implemented as a hardware processor such as a central processing unit (CPU). Processor 802 may be implemented as one or more circuits capable of carrying out instructions contained in program code. The circuit(s) may be an IC or embedded in an IC. Processor 802 may be implemented using a complex instruction set computer architecture (CISC), a reduced instruction set computer architecture (RISC), a vector processing architecture, or other known architectures. Example processors include, but are not limited to, processors having an x86 type of architecture (IA-32, IA-64, etc.), Power Architecture, ARM processors, and the like.

Bus 806 represents one or more of any of a variety of communication bus structures. By way of example, and not limitation, bus 806 may be implemented as a Peripheral Component Interconnect Express (PCIe) bus. Data processing system 800 typically includes a variety of computer system readable media. Such media may include computer-readable volatile and non-volatile media and computer-readable removable and non-removable media.

Memory 804 can include computer-readable media in the form of volatile memory, such as random-access memory (RAM) 808 and/or cache memory 810. Data processing system 800 also can include other removable/non-removable, volatile/non-volatile computer storage media. By way of example, storage system 812 can be provided for reading from and writing to a non-removable, non-volatile magnetic and/or solid-state media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 806 by one or more data media interfaces. Memory 804 is an example of at least one computer program product.

Memory 804 is capable of storing computer-readable program instructions that are executable by processor 802. For example, the computer-readable program instructions can include an operating system, one or more application programs, other program code, and program data. Processor 802, in executing the computer-readable program instructions, is capable of performing the various operations described herein that are attributable to a computer. In one or more examples, the computer-readable program instructions may include RAD metadata generator 112 and/or any or all of the blocks included in source system 102.

Data processing system 800 may include one or more Input/Output (I/O) interfaces 818 communicatively linked to bus 806. I/O interface(s) 818 allow data processing system 800 to communicate with one or more external devices and/or communicate over one or more networks such as a local area network (LAN), a wide area network (WAN), and/or a public network (e.g., the Internet). Examples of I/O interfaces 818 may include, but are not limited to, network cards, modems, network adapters, hardware controllers, etc. Examples of external devices also may include devices that allow a user to interact with data processing system 800 (e.g., a display, a keyboard, and/or a pointing device) and/or other devices such as accelerator card.

Data processing system 800 is only one example implementation. Data processing system 800 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

As used herein, the term “cloud computing” refers to a computing model that facilitates convenient, on-demand network access to a shared pool of configurable computing resources such as networks, servers, storage, applications, ICs (e.g., programmable ICs) and/or services. These computing resources may be rapidly provisioned and released with minimal management effort or service provider interaction. Cloud computing promotes availability and may be characterized by on-demand self-service, broad network access, resource pooling, rapid elasticity, and measured service.

The example of FIG. 8 is not intended to suggest any limitation as to the scope of use or functionality of example implementations described herein. Data processing system 800 is an example of computer hardware that is capable of performing the various operations described within this disclosure. In this regard, data processing system 800 may include fewer components than shown or additional components not illustrated in FIG. 8 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

Data processing system 800 may be operational with numerous other general-purpose or special-purpose computing system environments or configurations. Examples of computing systems, environments, and/or configurations that may be suitable for use with data processing system 800 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of a computer-readable storage medium or two or more computer-readable storage mediums. A non-exhaustive list of examples of a computer-readable storage medium include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, the phrase “in response to” and the phrase “responsive to” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “user” refers to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the terms “one embodiment,” “an embodiment,” “one or more embodiments,” “particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” or “outputting” means storing in physical memory elements, e.g., devices, writing to display or other peripheral output device, sending or transmitting to another system, exporting, or the like.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the inventive arrangements described herein. Within this disclosure, the terms “program code,” “program instructions,” and “computer-readable program instructions” are used interchangeably. Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives program instructions from the network and forwards the computer-readable program instructions for storage in a computer-readable storage medium within the respective computing/processing device.

Program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Program instructions may include state-setting data. The program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the program instructions by utilizing state information of the program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by program instructions, e.g., program code.

These program instructions may be provided to a processor of a computer, special-purpose computer, or other programmable data processing apparatus to produce a machine, such that the program instructions, which execute via the processor of the computer or other programmable data processing apparatus, create means for implementing the functions/acts specified in the flowchart and/or block diagram block or blocks. These program instructions may also be stored in a computer-readable storage medium that can direct a computer, a programmable data processing apparatus, and/or other devices to function in a particular manner, such that the computer-readable storage medium having program instructions stored therein comprises an article of manufacture including program instructions which implement aspects of the operations specified in the flowchart and/or block diagram block or blocks.

The program instructions may also be loaded onto a computer, other programmable data processing apparatus, or other device to cause a series of operations to be performed on the computer, other programmable apparatus or other device to produce a computer implemented process, such that the program instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more program instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and program instructions.

The descriptions of the various embodiments of the disclosed technology have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
generating, using computer hardware, histogram-based data for video including one or more frames, wherein the histogram-based data is generated for each of a plurality of dynamic ranges;
for each dynamic range, generating, using the computer hardware, a predetermined amount of dynamic metadata for the video from the histogram-based data for the dynamic range; and
outputting the video and the dynamic metadata for the plurality of dynamic ranges.

2. The method of claim 1, wherein the dynamic metadata for the plurality of dynamic ranges specifies a tonality representation of the video for high dynamic range tone mapping.

3. The method of claim 1, wherein the plurality of dynamic ranges includes at least one of a dark dynamic range or a bright dynamic range.

4. The method of claim 1, wherein the plurality of dynamic ranges includes a dark dynamic range, a mid-tone dynamic range, and a bright dynamic range.

5. The method of claim 1, wherein the dynamic metadata for each dynamic range specifies percentile information and luminance information.

6. The method of claim 5, wherein the dynamic metadata for each dynamic range specifies a predetermined number of percentile-luminance pairs.

7. The method of claim 6, wherein the predetermined number of percentile-luminance pairs for each dynamic range of the plurality of dynamic ranges is independently specified.

8. The method of claim 1, wherein the plurality of dynamic ranges is defined by one or more luminance thresholds, wherein each luminance threshold defines a boundary separating adjacent dynamic ranges of the plurality of dynamic ranges.

9. The method of claim 1, wherein the generating the histogram-based data comprises:
generating a maximum red-green-blue (RGB) frame for a selected frame of the video;
generating a range-specific maximum RGB frame for each dynamic range of the plurality of dynamic ranges;
generating a range-specific histogram for each range-specific maximum RGB frame; and
generating a range-specific cumulated distribution function for each range-specific histogram.

10. The method of claim 9, wherein the generating the predetermined amount of dynamic metadata comprises:
generating one or more percentile-luminance pairs from each range-specific cumulated distribution function.

11. A system, comprising:
a memory capable of storing program instructions; and
a processor coupled to the memory, wherein the processor is capable of executing the program instructions to perform operations including:
generating histogram-based data for video including one or more frames, wherein the histogram-based data is generated for each of a plurality of dynamic ranges;
for each dynamic range, generating a predetermined amount of dynamic metadata for the video from the histogram-based data for the dynamic range; and
outputting the video and the dynamic metadata for the plurality of dynamic ranges.

12. The system of claim 11, wherein the dynamic metadata for the plurality of dynamic ranges specifies a tonality representation of the video for high dynamic range tone mapping.

13. The system of claim 11, wherein the plurality of dynamic ranges includes at least one of a dark dynamic range or a bright dynamic range.

14. The system of claim 11, wherein the plurality of dynamic ranges includes a dark dynamic range, a mid-tone dynamic range, and a bright dynamic range.

15. The system of claim 11, wherein the dynamic metadata for each dynamic range specifies percentile information and luminance information.

16. The system of claim 15, wherein the dynamic metadata for each dynamic range specifies a predetermined number of percentile-luminance pairs.

17. The system of claim 16, wherein the predetermined number of percentile-luminance pairs for each dynamic range of the plurality of dynamic ranges is independently specified.

18. The system of claim 11, wherein the plurality of dynamic ranges is defined by one or more luminance thresholds, wherein each luminance threshold defines a boundary separating adjacent dynamic ranges of the plurality of dynamic ranges.

19. The system of claim 11, wherein the generating the histogram-based data comprises:
generating a maximum red-green-blue (RGB) frame for a selected frame of the video;
generating a range-specific maximum RGB frame for each dynamic range of the plurality of dynamic ranges;
generating a range-specific histogram for each range-specific maximum RGB frame; and
generating a range-specific cumulated distribution function for each range-specific histogram.

20. A computer program product, comprising:
a computer readable storage medium having program instructions embodied therewith, wherein the program instructions are executable by computer hardware to cause the computer hardware to perform operations including:
generating histogram-based data for video including one or more frames, wherein the histogram-based data is generated for each of a plurality of dynamic ranges;
for each dynamic range, generating a predetermined amount of dynamic metadata for the video from the histogram-based data for the dynamic range; and
outputting the video and the dynamic metadata for the plurality of dynamic ranges.
